(19) United States
(12) Patent Application Publication
(10) Pub. No.: US 2002/0161069 A1
(43) Pub. Date: Oct. 31, 2002

(54) Inkjet recording fluid containing resin-in-aqueous-emulsion

(76) Inventors: Moshe Frenkel, Jerusalem (IL); Jankiel Kimelblat, Ra'anana (IL); Ilan Hidana, Kadima (IL); Boaz Nitzan, Ganey-Tikva (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/046,752

(22) Filed: Jan. 17, 2002

Related U.S. Application Data
(60) Provisional application No. 60/262,061, filed on Jan. 18, 2001.

(51) Int. Cl. C03C 17/00; C09D 5/00

(52) U.S. Cl. 523/160; 523/161

(57) ABSTRACT

A clog-free jettable fluid composition and a method for producing the same are provided. According to some embodiments of the present invention, the jettable fluid comprises water as solvent, a resin-in-aqueous-emulsion having an acid number of at least 30, and an alkaline agent. The jettable fluid has a pH above 9.

According to other embodiments, the jettable fluid comprises water as solvent, a resin-in-aqueous-emulsion having an acid number below 30, an acrylic resin-in-aqueous-solution and an alkaline agent. The resin composition of the resin-in-aqueous-emulsion and resin-in-aqueous-solution has an acid number of at least 30 and the jettable fluid has a pH above 9.

### CROSS-REFERENCE TO RELATED APPLICATIONS

The present application claims priority from US provisional application serial number 60/262,061, filed Jan. 18, 2001.

### BACKGROUND OF THE INVENTION

A large number of inkjet recording fluids are used for inkjet printing, among those water-based inks Be commonly used. Compared to solvent-based inks, water-based inks have many advantages such as, non-hazardous and environmental friendly usage. Generally, home and office inkjet printers use aqueous inks that do not contain resin. Therefore, these inks may not have desired properties such as proper adhesion to a variety of substrates (both porous and non-porous ones), high abrasion resistance, and short drying times, commonly required in industrial printing applications.

Inks comprising acrylic resins may have the desired industrial properties mentioned above, however the addition of resin to the ink may significantly increase the ink viscosity to an unacceptable level, which may be too high for jetting applications. Furthermore, addition of resin may increase the solid content of the in thus inducing clogging and/or malfunction of the nozzles resulting in low reliability of the printing system

Two types of resins may be used in ink systems: an acrylic resin in aqueous solution and an acrylic resin in emulsion. Adding resin-in-emulsion has several advantages as compared to resin-in-solution, for example, lower viscosity of the ink formulation and higher abrasion resistance due to the higher molecular weight of the resin-in-emulsion, better adhesion to a variety of substrates, and higher drying rates.

A major problem of using ink having acrylic resin in emulsion is partial or complete clogging of nozzles. The drying of ink having resin in solution is a reversible process because the dried resin may re-dissolve in the ink. A resin-in-emulsion, however, is generally a thermodynamically unstable system. Therefore, once the ink layer dries and forms a solid film it may not be possible to re-dissolve it. The result of this phenomenon is consequently nozzle clogging and a significant deterioration of print quality. Even partially clogged nozzles may significantly affect the directionality of jetted droplets. This ‘irreversible drying’ phenomenon is inherent to substantially all fluids containing resin-in-emulsions.

Therefore, jettable ink compositions containing resin-in-emulsion suffer from substantial unreliability, limiting their usage and/or requiring print head maintenance cycles at substantially short intervals, thereby reducing significantly production throughput. Furthermore, in order to resolve the clogging problems, caused by the dried-up film at the nozzles, the above-mentioned maintenance cycles commonly require usage of costly rind sometimes hazardous cleaning substances.

### SUMMARY OF THE INVENTION

Some embodiments of the present invention are directed to a clog-free jettable fluids composition and a method for producing the same. The fluid comprises resin-in-emulsion or a resin composition comprising a resin-in-emulsion and resin-in-solution.

There is therefore provided in accordance with some embodiments of he present invention a jettable fluid and method of producing such. The jettable fluid comprises water, a resin-in-aqueous-emulsion having an acid number of at least 30 and an alkaline agent. The jettable fluid has a pH above 9.

There is also provided, in accordance with other embodiments of the present invention a jettable fluid and a method of producing such. The jettable fluid comprises water, a resin-in-aqueous-emulsion having an acid number of below 30, an acrylic resin-in-aqueous-solution and an alkaline agent. The resin composition of the resin-in-emulsion and resin-in-solution has an acid number of at least 30 and the jettable fluid has a pH above 9.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description on when read with the accompanying drawings in which:

FIG. 1 is an exemplary jetting pattern when using a known resin-in-emulsion ink; and

FIG. 2 is a jetting pattern when using an ink composition according to some embodiments of the present invention;

It will be appreciated that for simplicity and clarity of illustration, elements shown in the figures have not necessarily been drawn to scale, For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the description below, a particular application of jetting inks in the printing industry is discussed and therefore the term ink is predominantly used for fluid. It should be mentioned here that a multitude of jetting applications might benefit from the teachings of the present invention. Non-limiting examples of jetting applications include markings in the packaging print industry, and varnishes in the printing industry. Therefore, the term ink may be substituted by coating, marking, varnish or any other term used by persons versed in the art of a particular application field wherein a fluid containing resin-in-aqueous-emulsion is jetted. Therefore, the particular examples and references to printing applications do not limit the present invention in any way.

Some embodiments of the present invention describe inkjet fluid formulations comprising resin-in emulsion, which may prevent nozzle clogging and may increase the reliability of the print heads. The recording fluid may comprise a resin-in-aqueous-emulsion or a composition of resin-in-aqueous-emulsion and resin-in-aqueous-solution. The fluid may achieve proper adhesion to a variety of substrates (both porous and non-porous ones), high abrasion resistance, and short drying times.

In the discussion following below, the term “acid number” is introduced. Acid number is known in the art as the number of milligrams of KOH required to neutralize 1 gram of a resin and is generally provided by He resin supplier.

According to some embodiments of the present invention, a jettable fluid, such as jettable ink may comprise water as the main aqueous carrier and a resin-in-aqueous-emulsion having an acid number of at least 30. The resin-in-aqueous-emulsion may be any stabilized composition. Non-limiting examples of resin-in-aqueous-emulsion include an acrylic resin, a styrene acrylic copolymer, a vinylidene chloride acrylic copolymer, vinyl acetate resins, use resins, petroleum resins, styrene-butadiene resin, vinyl chloride resin, polybutadiene resin or styrene resin.

The fluid may further comprise suitable quantities of organic or/and in-organic, water-soluble alkaline agent so that the pH level of the fluid exceeds 9.0. The free carboxylic groups, which may be available in the resin, may re-dissolve by the basic ink solution. Therefore a dried solid film of ink, which may be formed at the nozzles may redissolve.

The fluid may further comprise colorants such as pigments and dyes, surfactants for enabling proper wetting of the ink on various substrates, coalescence agents, humectants for preventing drying of the ink in the print head nozzles and additives, such as, preservatives, anti-molds and the like for providing improved storage and shelf stability.

Those versed in the art will readily appreciate that for other applications, one or more components nay be omitted or substituted by other constituents. For example, for coating applications, the colorants may be omitted or substituted by one or more colorless substances. Furthermore, in coating formulations, commonly not requiting surfactants, these components may by omitted.

According to other embodiments of the present invention, a jettable fluid, such as jettable ink may comprise water as the main aqueous carrier, a resin-in-aqueous-emulsion having an acid number below 30, and an acrylic resin-in-aqueous-solution having an acid number above 30 so that the acid number of the resin composition comprising both the resin-in-emulsion and the resin-in-solution exceeds 30. The acid number of the acrylic resin in solution may exceed 50. The fluid may further comprise suitable quantities of organic or/and in-organic, water-soluble alkaline agent so that the pH level of the fluid exceeds 9.0.

The jettable fluid composition described hereinabove may be substantially ‘clog free’, thus alleviating the predicaments of prior art resin-in-aqueous-emulsion compositions. The stabilization process generated by the alkaline solution may provide the inkjet fluid the desired anti-clogging properties. Furthermore, if the resin-in-aqueous-emulsion has an acid number that exceeds 30, then Ply the pH level may be adjusted to exceed 9.0 and if the resin-in-aqueous-emulsion has an acid number below 30, then in addition to adjusting the pH to an alkalinity level exceeding 9.0, a suitable quantity of an acrylic polymer aqueous solution may be added so that the resin composition comprising the resin-in-emulsion and the acrylic resin-in-aqueous-solution has an acid number of at least 30.

Adding a suitable amount of acrylic resin-in aqueous solution to a fluid having resin-in aqueous-emulsion having a low acid number may ensure that the resin composition comprises a sufficient amount of free carboxylic groups per each gram of resin. Adding an alkaline agent to the ink composition may set the pH level of the fluid to above 9.0. Consequently, the carboxylic groups may be neutralized by a counter-cation, increasing substantially the water solubility of the resin-in-aqueous-solution. The acrylic resin-in-aqueous-solution may then re-dissolve from within the dried ink and may generate a process of disintegration of the film.

When using an ink composition according to some embodiments of the present invention, the solid film, which may be formed at the nozzles may be re-dissolved, thus substantially alleviating the ‘irreversible drying’ problem of previous ink containing resin-in-aqueous-emulsion compositions.

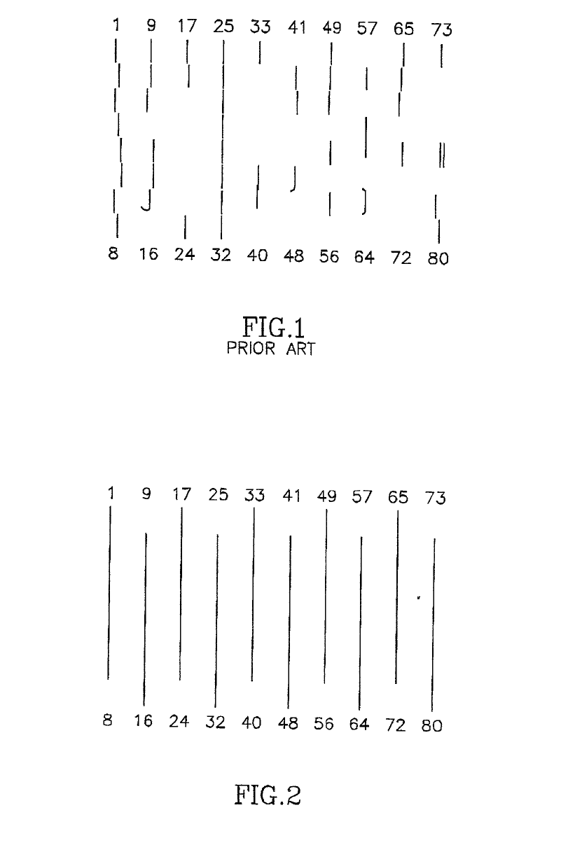

Attention is now directed to FIG. 1, showing a common, actual jetting pattern of prior art resin-in-emulsion ink after a short time of jetting, characterized by irregular jetting of nozzles, spraying and partial clogging. Those versed in the art will readily recognize that even partially clogged nozzles will have a non-perpendicular to nozzle plate trajectory, which in addition, may vary in direction from one jetted droplet to the next one.

Reference is now made to FIG. 2, which is a schematic illustration of a jetting pattern of clean nozzles when using an ink composition according to some embodiments of the present invention. The pattern is produced by jetting ink from a 512 nozzles print head using the “one-out-of 8 nozzles” technique. The one-out-of 8 active nozzle technique is particular useful in estimating the amount of residual resin built-up in close vicinity of a nozzle.

The examples below represent various formulations, which demonstrate that re-solubility of dried up resins in fluids containing resin-in-aqueous-emulsion has been substantially achieved. These inks do not show any mis-directionality even after long periods of continuous printing. While in the examples described below organic alkaline solutions are utilized, optionally inorganic water-soluble, alkaline solutions such as sodium hydroxide may be utilized.

Examples 1-4 demonstrate a CMYK ink-set formulation in accordance with some embodiments of the present invention. In example 1 a black pigment is used, in example 2 a magenta pigment is used, in example 3 a cyan pigment is used, and in example 4, a yellow pigment is used. In these examples, an amine (2-amino 2-methyl 1-propanol) has been added at a concentration of 0.5%.

In examples 5-7, the amine has been added in various concentrations to the formulation of example 1. In example 5, the pH of the fluid is 9.1 when 0.3% (weight base) of amine is added. In example 6, the pH of the fluid is 9.6 when 0.4%/0 (weight base) of amine is added. In example 7, the pH of the fluid is 10.3 when 2.0% (weight base) of amine is added.

Examples 8-11 demonstrate ink formulations in which different materials are used to bring the alkalinity of the composition to the desired level exceeding 9.0. In examples 8 and 10; two organic amine compounds axe used while in example 9, ammonia solution is added to the formulation and in example 11, sodium hydroxide solution is used.

Three additional different black pigments have been used as part of the ink formulation in examples 12 to 14 showing results substantially identical to that of example 2. Example 15 is a reference formulation of a resin-in-emulsion containing ink and having a pH of 8.4. Therefore, mis-directionality is observed when using the ink formulation of example 15. The jetting pattern in FIG. 1 has been produced by this reference formulation.

While ill examples 1-15 and 18-20 Joncryl 538 resin, made by S. C. Johnson, has been used, examples 16 and 17 are formulations with other resins showing similar behavior and thus, can be substituted. Examples 18 and 20 axe formulations wherein a dye is used instead of a pigment as the colorant.

Example 21 demonstrates an ink formulation to which an amine has been added to achieve die desired pH level, however the acid number of the composition in 20. Therefore, mis-directionality followed by clogging of nozzles is observed when using the ink formulation of example 21. Example 22 demonstrates an ink formulation comprising both resin-in-emulsion and resin-in-solution. No alkaline solution has been added to this formulation. Therefore, mis-directionality followed by clogging of nozzles is observed when using the in, formulation of example 22.

Example 23 is identical to example 22 and further comprising an alkaline solution. The pH level of the composition is 9.3 and the formulation is free from clogging or mis-directionality.

### EXAMPLES

In following examples of recording fluid compositions, component designations are in solid weigh percentages. Furthermore, all the examples are prepared in a similar manner as example 1, which preparation is described in more detail below.

It is noted that the following examples do not limit in any way the scope of the present invention.

| Weight % | Ingredient |
|---|---|
| 10 | acrylic polymer emulsion, sold under the trade name of Joncryl 538 by |
| | S.C Johnson. Acid number 64 |
| 35 | di propylene glycol (DPG) |
| 5 | Glycerol, humectant |
| 0.5 | 2-amino-2 methyl 1-propanol, alkaline pH adjusting solution |
| 0.2 | Black pigment sold under the trade name of Hostafine Black TS by |
| | Clariant GmbH |
| 0.25 | BYK-345 surfactant or wetting agent |
| 0.02 | BYK-307 wetting agent |
| balance | de-ionized water |

pH = 9.8

The inkjet marking fluid composition listed above was prepared in the following mixing order;

de-ionized water;

adding dipropylene glycol (DPG);

adding Glycerol;

adding 2-amino-2 methyl-1 propanol;

adding Joncryl 538 while mixing;

adding pigment dispersion of Hostasfine black TS;

adding BYK 345 as a surfactant or wetting agent and BYK 307;

adding balance of de-ionized water; and

continuing mixing or half an hour.

### Example 2

| Weight % | Ingredient |
|---|---|
| 10 | acrylic polymer emulsion sold under the trade name of Joncryl 538 by |
| | S.C Johnson. Acid number 64 |
| 35 | di-ethylene glycol (DEG), humectant |
| 5 | Glycerol, humectant |
| 0.5 | 2-amino-2 methyl 1-propanol, alkaline pH adjusting solution |
| 6 | Magenta pigment sold under the trade name of Hostafine Rubin F6B |
| | by Clariant GmbH |
| 0.3 | BYK-345 surfactant or wetting agent |
| 0.02 | BYK-307 wetting agent |
| balance | de-ionized water |

pH = 9.8

### Example 3

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 0.5 | 2-amino-2 methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | de-ionized water |

pH = 9.8

### Example 4

| Weight % | Ingredient |
|---|---|
| 10 | acrylic polymer emulsion, sold under the trade name of Joncryl 538 by |
| | S.C Johnson. Acid number 64 |
| 20 | di-propylene glycol (DPG), humectant |
| 10 | di-ethylene glycol (DEG), humectant |
| 10 | propylene glycol(PG) humectant |
| 5 | Glycerol, humectant |
| 0.5 | 2-amino-2 methyl 1-propanol, alkaline pH adjusting solution |
| 2.5 | Yellow pigment sold under the trade name of Hostafine Yellow GR by |
| | Clariant GmbH |
| 0.3 | BYK-345 surfactant or wetting agent |
| 0.02 | BYK-307 wetting agent |
| balance | de-ionized water |

pH = 9.75

### Example 5

| Weight % | Ingredient |
|---|---|
| 10 | acrylic polymer emulsion, sold under the trade name of Joncryl 538 by |
| | S.C Johnson. Acid number 64 |
| 35 | tri ethylene glycol (TEG), humectant |
| 0.3 | 2-amino 2-methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | de-ionized water |

pH = 9.1

### Example 6

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.4 | 2-amino-2 methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | de-ionized water |

pH = 9.6

### Example 7

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 2 | 2-amino-2 methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | De-ionized water |

pH = 10.3

### Example 8

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | tri-ethanol amine, pH adjusting solution |
| 5.2 | Black pigment sold under the trade name of Hostafine Black TS by |
| | Clariant GmbH |
| 0.25 | BYK-345 surfactant or wetting agent |
| 0.02 | BYK-307 wetting agent |
| balance | de-ionized water |

pH = 9.5

### Example 9

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | Ammonia (NH4OH), pH adjusting solution |
| 5.2 | Black pigment sold under the trade name of Hostafine Black TS by |
| | Clariant GmbH |
| 0.25 | BYK-345 surfactant or wetting agent |
| 0.02 | BYK-307 wetting agent |
| balance | de-ionized water |

pH = 9.3

### Example 10

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | di-methyl ethanol amine pH adjusting solution |
| 5.2 | Black pigment sold under the trade name of Hostafine Black TS by |
| | Clariant GmbH |
| 0.25 | BYK-345 surfactant or wetting agent |
| 0.02 | BYK-307 wetting agent |
| balance | de-ionized water |

pH = 9.6

### Example 11

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | Sodium hydroxide (NaOH) pH adjusting solution |
| 5.2 | Black pigment sold under the trade name of Hostafine Black TS by |
| | Clariant GmbH |
| 0.25 | BYK-345 surfactant or wetting agent |
| 0.02 | BYK-307 wetting agent |
| balance | de-ionized water |

pH = 9.8

### Example 12

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | 2-amino-2 methyl 1-propanol, alkaline pH adjusting solution |
| 20 | Black pigment sold under the trade name of Liojet Black Base by Toyo |
| | Japan |
| 0.25 | BYK-345 surfactant or wetting agent |
| 0.02 | BYK-307 wetting agent |
| balance | de-ionized water |

pH = 9.8

### Example 13

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | 2-amino-2 methyl 1-propanol, alkaline pH adjusting solution |
| 23 | Black pigment sold under the trade name of Cabot 8247-7 by Cabot |
| 0.3 | BYK-345 surfactant or wetting agent |
| 0.02 | BYK-307 wetting agent |
| balance | de-ionized water |

pH = 9.8

### Example 14

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | 2-amino-2 methyl 1-propanol, alkaline pH adjusting solution |
| 14 | Black pigment sold under the trade name of Idis 15 by Degussa |
| 0.25 | BYK-345 surfactant or wetting agent |
| 0.02 | BYK-307 wetting agent |
| balance | de-ionized water |

pH = 9.8

### Example 15

| Weight % | Ingredient |
|---|---|
| 10 | acrylic polymer emulsion, sold under the trade name of Joncryl 538 by |
| | S.C Johnson. Acid number 64 |
| 45 | di-propylene glycol (DPG), humectant |
| 5.2 | Black pigment sold under the trade name of Hostafine Black TS by |
| | Clariant GmbH |
| 0.3 | BYK-345 surfactant or wetting agent |
| 0.02 | BYK-307 wetting agent |
| balance | de-ionized water |

pH = 8.4

### Example 16

| Weight % | Ingredient |
|---|---|
| 14.28 | acrylic polymer emulsion, sold under the trade name of Lucidene 141 |
| | by Morton. Acid number 32 |
| 35 | di-propylene glycol (DPG), humectant |
| 5 | Glycerol, humectant |
| 0.5 | 2-amino-2 methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | de-ionized water |

pH = 9.85

### Example 17

| Weight % | Ingredient |
|---|---|
| 13.33 | acrylic polymer emulsion, sold under the trade name of Lucidene 143 |
| | by Morton. Acid number 32 |
| 35 | di-propylene glycol (DPG), humectant |
| 5 | Glycerol, humectant |
| 0.5 | 2-amino-2 methyl 1-propanol, alkaline pH adjusting solution |
| 3.34 | Cyan pigment sold under the trade name of Hostafine Blue B2G by |
| | Clariant GmbH |
| 0.3 | BYK-345 surfactant or wetting agent |
| 0.02 | BYK-307 wetting agent |
| balance | de-ionized water |

pH = 9.8

### Example 18

| Weight % | Ingredient |
|---|---|
| 10 | acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 0.5 | 2-amino-2 methyl 1-propanol, alkaline pH adjusting solution |
| 12.5 | Cyan Dye sold under the trade name of Bayscript Cyan BA |
| 0.3 | BYK-345 surfactant or wetting agent |
| 0.02 | BYK-307 wetting agent |
| balance | de-ionized water |

pH = 9.95

### Example 19

| Weight % | Ingredient |
|---|---|
| 10 | Acrylic polymer emulsion, sold under the trade name of Joncryl 538 by |
| | S.C Johnson. Acid number 64 |
| 35 | di-propylene glycol (DPG), humectant |
| 5 | Glycerol humectant |
| 0.5 | 2-amino-2 methyl 1-propanol, alkaline pH adjusting solution |
| 1 | di-propylene glycol mono methyl ether (DPM), humectant |
| 5.2 | Black pigment sold under the trade name of Hostafine black TS |
| 0.3 | BYK-345 surfactant or wetting agent |
| 0.02 | BYK-307 wetting agent |
| balance | de-ionized water |

pH = 9.7

### Example 20

| Weight % | Ingredient |
|---|---|
| 10 | Acrylic polymer emulsion, sold under the trade name of Joncryl 538 by |
| | S.C Johnson. Acid number 64 |
| 35 | di-propylene glycol (DPG), humectant |
| 5 | Glycerol, humectant |
| 12.5 | Cyan Dye sold under the trade name of Bayscript Cyan BA |
| 0.3 | BYK-345 surfactant or wetting agent |
| 0.02 | BYK-307 wetting agent |
| balance | de-ionized water |

pH = 8.2

### Example 21

pH = 10.4

| Weight % | Ingredient |
|---|---|
| 9.8 | acrylic polymer emulsion, sold under the trade name Carboset |
| | GA 2182 by BF Goodrich. Acid number 20 |
| 35 | di-propylene glycol (DPG), humectant |
| 5 | Glycerol, humectant |
| 0.5 | 2-amino-2 methyl 1-propanol, alkaline pH adjusting solution |
| 3.34 | Cyan pigment sold under the trade name of Hostafine Blue |
| | B2G by Clariant GmbH |
| 0.3 | BYK-345 surfactant or wetting agent |
| 0.01 | BYK-307 wetting agent |
| balance | de-ionized water |

### Example 22

pH = 8.3

| Weight % | Ingredient |
|---|---|
| 4 | acrylic polymer emulsion, sold under the trade name of |
| | Joncryl 538 by S.C. Johnson. Acid number 64 |
| 6.6 | Acrylic polymer solution, sold under the trade name of |
| | Joncryl 586 by S.C. Johnson |
| 6.25 | Acrylic polymer solution, sold under the trade name of |
| | Joncryl SCX-8078 by S.C. Johnson |
| 35 | di-propylene glycol (DPG)), humectant |
| 5 | Glycerol, humectant |
| 3.34 | Cyan pigment sold under the trade name of Hostafine Blue |
| | B2G by Clariant GmbH |
| 0.3 | BYK-345 surfactant or wetting agent |
| 0.01 | BYK-307 wetting agent |
| balance | de-ionized water |

### Example 23

pH = 9.3

| Weight % | Ingredient |
|---|---|
| 4 | acrylic polymer emulsion, sold under the trade name of |
| | Joncryl 538 by S.C. Johnson |
| 6.6 | Acrylic polymer solution, sold under the trade name of |
| | Joncryl 586 by S.C. Johnson |
| 6.25 | Acrylic polymer solution, sold under the trade name of |
| | Joncryl SCX-8078 by S.C. Johnson |
| 0.5 | Tri methanol amine pH adjusting solution |
| 35 | di-propylene glycol (DPG), humectant |
| 5 | Glycerol, humectant |
| 3.34 | Cyan pigment sold under the trade name of Hostafine Blue |
| | B2G by Clariant GmbH |
| 0.3 | BYK-345 surfactant or wetting agent |
| 0.01 | BYK-307 wetting agent |
| balance | de-ionized water |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A jettable fluid comprising:
water;
a resin-in-aqueous-emulsion having an acid number of at leas 30; and
an alkaline agent
wherein the pH of said jettable fluid exceeds 9.0.

2. The jettable fluid of claim 1 further comprising:
one or more humectants;
one or more surfactants; and
one or more additives.

3. The jettable fluid of Claim 2 further comprising one or more colorants.

4. The jettable fluid of claim 2 further comprising one or more coalescence agents.

5. A jettable fluid comprising:
water;
a resin composition comprising:
a resin-in-aqueous-emulsion having all acid number below 30; and
a suitable amount of an acrylic resin-in-aqueous-solution,
wherein said resin composition bas an acid number of at least 30; and
an alkaline agent,
wherein the pH of said jettable fluid exceeds 9.0.

6. The jettable fluid of claim 5 further comprising:
one or more humectants;
one or more surfactants; and
one or more additives.

7. The jettable fluid of claim 6 further comprising one or more colorants.

8. The jettable fluid of claim 6 further comprising one or more coalescence agents.

9. The jettable fluid of claim 5, wherein said acrylic resin-in-aqueous-solution having an acid number exceeding 50.

10. The jettable fluid of claim 1, further comprising an additive for improved storage stability.

11. The jettable fluid of claim 5, further comprising an additive for improved storage stability.

12. The jettable fluid of claim 1, wherein said alkaline agent is a water-soluble organic agent, a water-soluble inorganic agent or a combination thereof.

13. The jettable fluid of claim 5, wherein said alkaline agent is a water-soluble organic agent, a water-soluble inorganic agent or a combination thereof.

14. The jettable fluid of claim 3, wherein at least one of said colorants is a pigment or dye.

15. The jettable fluid of claim 7, wherein at least one of said colorants is a pigment or a dye.

16. The jettable fluid of claim 1, wherein said resin-in-aqueous-emulsion is an acrylic resin, styrene-acrylic copolymer resin, vinylidene chloride acrylic copolymer, vinyl acetate resin, urethane resin, styrene-butadiene resin, vinyl chloride resin, polybutadiene resin or styrene resin.

17. The jettable fluid of claim 5, wherein said resin-in-aqueous-emulsion is an acrylic resin, styrene-acrylic copolymer resin, vinylidene chloride acrylic copolymer, vinyl acetate resin, urethane resin, styrene-butadiene resin, vinyl chloride resin, polybutadiene resin or styrene resin.

18. The jettable fluid of claim 1, wherein said jettable fluid is an ink for imaging printing applications.

19. The jettable fluid of claim 5, wherein said jettable fluid is an ink for imaging printing applications.

20. The jettable fluid of claim 1, wherein said jettable fluid is a varnish for printing applications.

21. The jettable fluid of claim 5, wherein said jettable fluid is a varnish for printing applications.

22. The jettable fluid of claim 1, wherein said jettable fluid is a marking fluid for packaging print applications.

23. The jettable fluid of claim 5, wherein said jettable fluid is a marking fluid for packaging print applications.

24. A method for preparing an aqueous jettable fluid comprising:
mixing a suitable amount of an alkaline agent with a jettable fluid comprising , resin-in-aqueous-emulsion having an acid number of at least 30 so that the pH of said fluid exceeds 9.0.

25. A method for preparing an aqueous jettable fluid comprising:
preparing a resin composition having an acid number of at least 30, said composition comprising a resin-in-aqueous-emulsion and an acrylic resin-in-aqueous-solution; and
adjusting the final pH of said jettable fluid so that the pH of said fluid exceeds 9.0.

26. The method of Claim 25, wherein preparing said resin composition comprises mixing said, resin-in-aqueous-emulsion and said acrylic resin-in-aqueous-solution, wherein said resin-in-aqueous-emulsion has an acid number below 30 and said acrylic resin-in-aqueous-solution has an acid number above 30.

27. The method of claim 25, wherein said acrylic resin-in-aqueous-solution has an acid number above 50.
